(19) United States
(12) Patent Application Publication
(10) Pub. No.: US 2010/0001977 A1
(43) Pub. Date: Jan. 7, 2010

(54) RESISTIVE TOUCH PANEL WITH MULTI-TOUCH RECOGNITION ABILITY

(75) Inventors: Gwo-Sen Lin, Taichung City (TW); Jian-Feng Lee, Taichung County (TW); Sherry Lin, Pingtung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Wintek Corporation, Taichung (TW)

(21) Appl. No.: 12/495,074

(22) Filed: Jun. 30, 2009

(30) Foreign Application Priority Data
Jul. 4, 2008 (TW) 097125174

(51) Int. Cl. G06F 3/045

(52) U.S. Cl. 345/174; 178/18.05

(57) ABSTRACT

A resistive touch panel with multi-touch recognition ability comprises: a top substrate, configured with at least two conductive electrodes; a bottom substrate, being integrated with the top substrate at a surface where the at least two conductive electrodes are formed; and an insulating layer, sandwiched between the top and the bottom substrates; wherein the bottom substrate is configured with four conductive electrodes to be used for forming two electric fields, one varying along an X-axis direction on a plane defined by a Cartesian coordinate system while enabling the other one to vary along a Y-axis direction of the same. With the aforesaid device, when there are multiple touches contact the top substrate at the same time, voltage variations relating to those touches can be detected from the bottom substrate for identifying the location of those touches and thus enabling the resistive touch panel with multi-touch recognition ability.

### FIELD OF THE INVENTION

The present invention relates to a resistive touch panel with multi-touch recognition ability, and more particularly, to a resistive touch panel capable of detect the voltage variations relating to each and every one of multiple simultaneous touches on its top substrate and also capable of identifying the location of those touches in a Cartesian coordinate system, and thereby, enabling the resistive touch panel to have not only a handwriting recognition ability, but also a multi-touch recognition ability as well as a touch-behavior identification ability.

### BACKGROUND OF THE INVENTION

A touch panel is a display which can detect the location of touches within the display area, usually performed either with the human hand or a stylus. This allows the display to be used as an input device, removing the keyboard and/or the mouse as the primary input device for interacting with the display's content. Such displays can be attached to computers or, as terminals, to networks. Touch panel also have assisted in recent changes in the design of personal digital assistant (PDA), global positioning system (GPS) and ultra-mobile personal computer (UMPC), making these devices more usable.

Technically speaking, there are four major types of touch panel in the market, which are Resistive type (Film on Glass), Capacitive type, Supersonic type, and Optical (Infrared) type. Among these four types of touch panel, resistive type is the most common one, which has approximately 60% of market share (the second is capacitive type with around 24% of market share). The major difference between the resistive touch panel and the capacitive touch panel is that: the capacitive touch panel is naturally designed with multi-touch capability so that it can detect and identify more than two contact points on its display area while using the multi-point identification as an input of a specific command such as image resizing or image rotating. On the other hand, although the resistive touch panels today are widely used on consuming electronic products, it is unable to identify multiple contact points simultaneously on its display area.

The technical principle of touch panel is that: when a finger or other media such as a touch pen touches the display area of a touch panel, the coordinate of the contact point will be located and identified by the detection of voltage, current, sonic wave or infrared light, and so on. There are two types of resistive (Film on Glass) touch panel, which are analog type touch panel and digital type touch panel. Generally, the analog type touch panel can further be divided into four-wire resistive touch panel, five-wire resistive touch panel, six-wire resistive touch panel, and eight-wire resistive touch panel. Please refer to FIG. 1, which shown a conventional five-wire resistive touch panel. In FIG. 1, the five-wire resistive touch panel 10 consists of a top substrate 11 and a bottom substrate 12, in which the two substrates 10, 11 are coated with conductive films respectively on surfaces facing toward each other. Moreover, there are four conductive electrodes X0, X1, Y0, and Y1 being disposed respectively at the four sides of the bottom substrate and each of the four electrodes is connected to an external control device by its own signal line 121. As an even resistance Rₓ is formed and exist between conductive electrodes X0 and X1, an electric fields capable of varying along an X-axis direction of a Cartesian coordinate system is defined on the surface of the bottom substrate 12, and thereby, an X axis is defined; and similarly, as an even resistance R_{y} is formed and exist between conductive electrodes Y0 and Y1, an electric fields capable of varying along an Y-axis direction of a Cartesian coordinate system is defined on the surface of the bottom substrate 12, and thereby, an Y axis is defined. In addition, there is a ring-like electrode 111 being formed on the conductive film of the top substrate 11 in a manner that it is surrounding the circumference of the conductive film and parallel to those detection electrodes on the bottom substrate 12. When the touch panel 10 is touched by an object at the P1 contact point as shown in FIG. 1, the top substrate 11 will be pressed to contact with the bottom substrate 12, and then by scanning the linearity resistance (analog signal) between the two conductive end on X and Y axis (i.e. the 4 electrodes=X0, X1, Y0, Y1), the external control device is able to convert these analog signals into coordination (x, y) data for programming use.

In short, the coordinate of a contact point touching a resistive touch panel is detected and located by the calculation of potential difference between electrodes on the bottom substrate in the X-axis direction and Y-axis direction. Comparing the five-wire resistive touch panel shown in FIG. 1 with those conventional four-wire resistive touch panel, the five-wire resistive touch panel is configured with an additional ring-like electrode 11 on its top substrate, forming a detection electrode covering the bottom substrate 12, so that, unlike those four-wire resistive touch panel that can be easily out of order as soon as its display area is scratched, the addition of the ring-like electrode 11 can ensure the touch panel to function normally even when its display area is being scratched and thus damaged. However, even though the five-wire resistive touch panel is much more durable than the four-wire resistive touch panel, the application of the five-wire resistive touch panel is limited as it is still unable to identify multiple contact points simultaneously on its display area.

### SUMMARY OF THE INVENTION

In view of the disadvantages of prior art, the object of the present invention is to provide a resistive touch panel with multi-touch recognition ability that has not only a handwriting recognition ability, but also a multi-touch recognition ability as well as a touch-behavior identification ability.

To achieve the above object, the present invention provides a resistive touch panel with multi-touch recognition ability, which comprises: a top substrate, configured with a plurality of conductive electrodes; and a bottom substrate, capable of being adhered and integrated to the bottom of the top substrate; wherein the bottom substrate is configured with four conductive electrodes to be used for forming two electric fields, one varying along an X-axis direction on a plane defined by a Cartesian coordinate system while enabling the other one to vary along a Y-axis direction of the same, and thereby, when there are multiple simultaneous touches contacting difference conductive electrodes on the top substrate, the bottom substrate is able to detect the voltage variations relating to each and every one of those simultaneous touches and thus capable of identifying the location of those touches in the Cartesian coordinate system.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shown a conventional five-wire resistive touch panel.

FIG. 2 and FIG. 3 are two exploded views of resistive touch panels according to two different embodiments of the invention.

FIG. 4 to FIG. 7 are schematic diagrams showing four different top substrates according to different embodiments of the invention.

FIG. 8 is a cross sectional view of a resistive touch panel of the invention.

FIG. 9 to FIG. 11 show a formation process of a top substrate used in a resistive touch panel of the invention in a step-by-step manner as well as the structure thereof.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

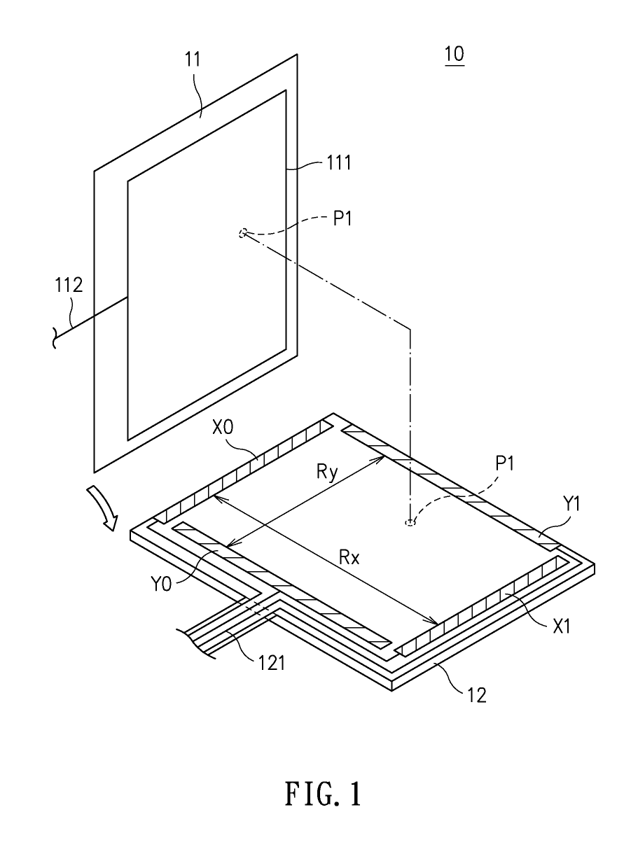

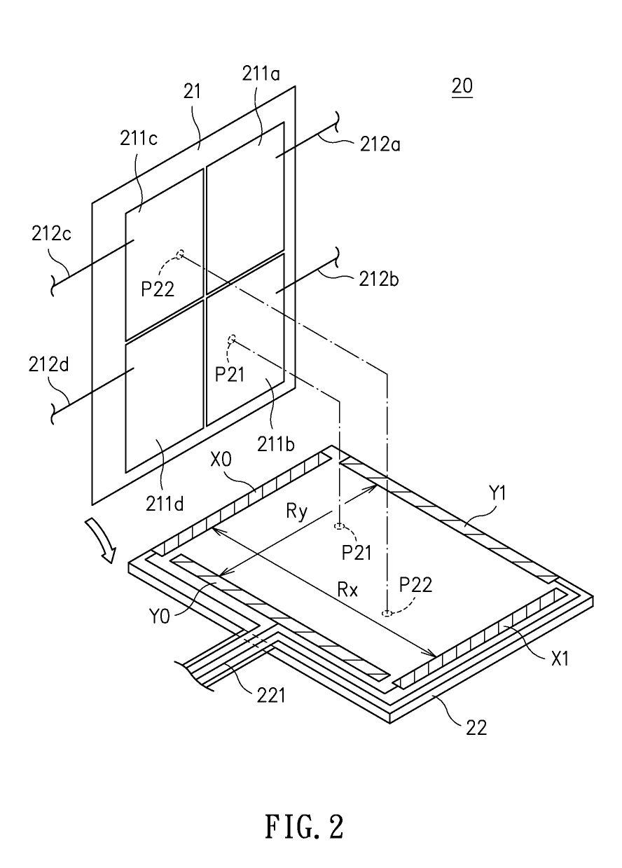

Please refer to FIG. 2, which is an exploded view of a resistive touch panel according to an embodiment of the invention. In FIG. 2, the resistive touch panel 20 comprises a top substrate 21 and a bottom substrate 22. Generally, the top and the bottom substrates 21, 22 can be made of a transparent material, such as glass, acrylic, poly carbonate (PC), polyethylene terephthalate (PET), and polyimide (PI). It is noted that the structure of the bottom substrate 22 is similar to the one shown in FIG. 1, which also has four conductive electrodes X0, X1, Y0, and Y1 being disposed respectively at the four sides of the bottom substrate 22 and each of the four electrodes is connected to an external control device by its own signal line 221. By the disposition of the two electrodes X0, X1, an electric fields capable of varying along an X-axis direction of a Cartesian coordinate system is defined on the surface of the bottom substrate 12, and similarly, by the disposition of the two electrodes Y0, and Y1, another electric fields capable of varying along an Y-axis direction of a Cartesian coordinate system is defined on the surface of the bottom substrate 12. In addition, there is an insulating layer to be arranged between the two electric fields, which can be made of an oxide or an organic polymer.

The characteristic of the invention is the plural conductive electrodes 211a˜211d formed on the top substrate 21 whereas the conductive electrodes 211a˜211d are connected respectively to their corresponding signal lines 212a˜212d and thereby connected to an external control device. It is noted that as the conductive electrodes 211a ˜211d are formed on the top substrate 21 at regions separated from each other, the contacts on the touch panel 20 at different regions can be identified and located by the detection of the plural conductive electrodes 211a˜211d. In FIG. 2, as there are two contact points P21, P22 touching the touch panel 20 at regions corresponding to the conductive electrodes 211b and 211c at which the top substrate 21 is pressed to contact with the bottom substrate 22, the signal lines 212b 212c connecting to the two conductive electrodes 211b and 211c are enabled to issue voltage signals to the external control device in response to the two contact points P21, P22, and thereby, the coordinate identification relating to the locating of the two contact points P21, P22 can be achieved by software or programming in successive so that the multi-touch detection is achieved. From the above description, it is noted that as there are four conductive electrodes 211a˜211d being formed in the aforesaid touch panel 20 and each is designed to detect a contact point independently from one another, the aforesaid touch panel 20 is able to detect up to four contact points at any given time so that it is a resistive touch panel with multi-touch recognition ability. Generally, the conductive electrodes X0, X1, Y0, Y1 formed on the bottom substrate 22 as well as the four conductive electrodes formed on the top substrate 21 can be made of a transparent material selected from the group consisting of: indium-tin oxide (ITO), indium doped zinc oxide (IZO), aluminum zinc oxide (AZO), Zinc oxide (ZnO), tin oxide (SnO).

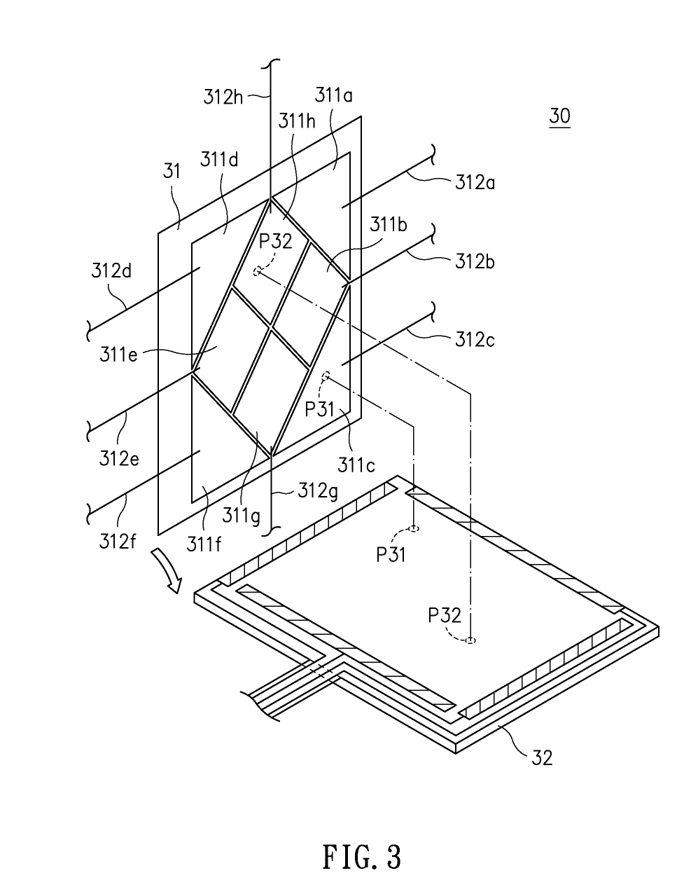

Please refer to FIG. 3, which an exploded view of a resistive touch panel according to another embodiment of the invention. Similarly, the resistive touch panel 30 is comprised of a top substrate 31 and a bottom substrate 32, in which the structure of the bottom substrate 32 is the same as the bottom substrate 12 shown in FIG. 1 and thus is not described further herein. The aforesaid embodiment is characterized in that: there are eight conductive electrodes 311a˜311h formed on the top substrate 31 whereas the conductive electrodes 311a˜311h are connected respectively to their corresponding signal lines 312a˜312h. As each of the conductive electrodes 311a˜311h is designed to detect a contact point independently from one another, the aforesaid touch panel 30 is able to detect up to eight contact points at any given time if those more that two contact points are formed at regions of the touch panel 30 corresponding to different conductive electrodes 311a˜311h. As shown in FIG. 3, the two contact points P31, P32 touch the touch panel 30 at regions corresponding to the conductive electrodes 311c and 311h at which the top substrate 31 is pressed to contact with the bottom substrate 32 for enabling the signal lines 312c˜312h to issue voltage signals to the external control device, and thereby, the multi-touch detection is achieved.

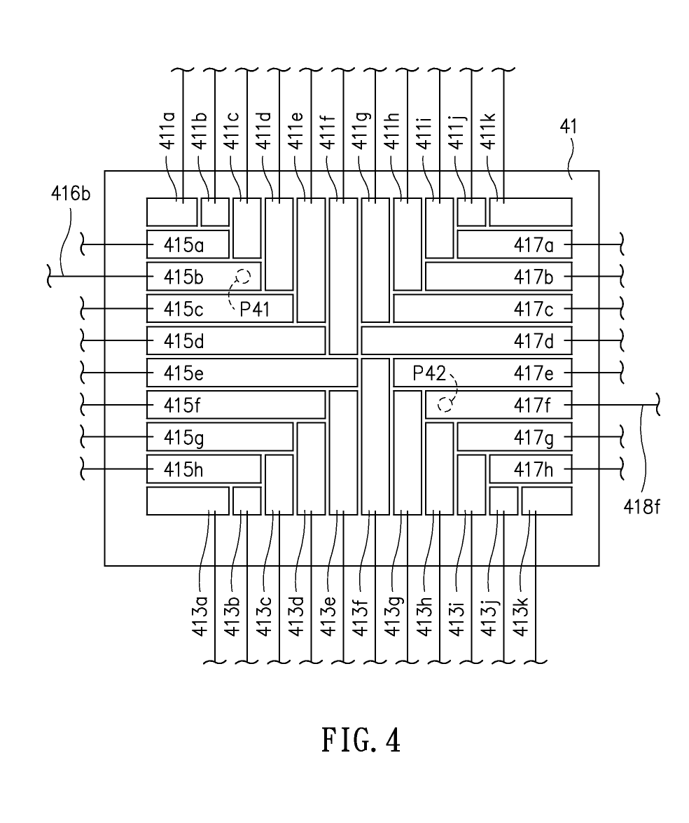

Please refer to FIG. 4, which is a schematic diagram showing a top substrate 41 according to an exemplary embodiment of the invention. The top substrate 41 of FIG. 4 can be integrated with a bottom substrate 32 similar to the one shown in FIG. 3 and thus form a resistive touch panel of multi-touch recognition ability. The aforesaid embodiment is characterized in that: there are a plurality of conductive electrodes 411a˜411k, 413a˜413k, 414a˜414h, 415a˜415h formed on the top substrate 41 whereas the conductive electrodes 411a˜411k, 413a˜413k, 414a˜414h, 415a˜415h are connected respectively to their corresponding signal lines. Generally, the multi-touch is being applied for image resizing, rotating, scrolling, dragging, and so on. Therefore, by arranging the conductive electrodes formed on the top substrate to be radially distributed as those shown in FIG. 4, the multi-touch of the resulting touch panel is adapted for the aforesaid operations of image resizing, rotating, scrolling and dragging since the arrangement of the radially distributed conductive electrodes is the arrangement most match to the hand movement of any user operating the aforesaid image operations. Similarly, each of the conductive electrodes 411a˜411k, 413a˜413k, 414a˜414h, 415a˜415h is designed to detect a contact point independently from one another, the resulting touch panel is able to detect up to thirty-eight contact points at any given time as there are thirty-eight conductive electrodes 411a˜411k, 413a˜413k, 414a˜414h, 415a˜415h formed on the top substrate 41. As shown in FIG. 4, the two contact points P41, P42 are located at regions corresponding to the conductive electrodes 415b and 417f at which the top substrate 41 is pressed to contact with the bottom substrate for enabling the signal lines 416b, 418f to issue voltage sign to the external control device as well as identify the coordinates of the two contact points P41, P42 so that the multi-touch recognition is achieved.

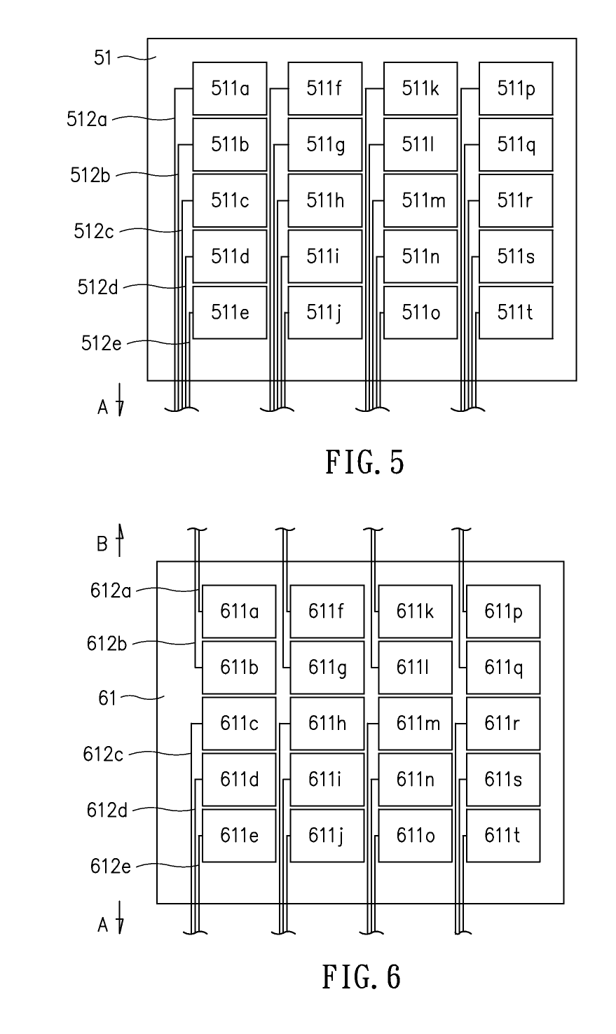

Please refer to FIG. 5, which is a schematic diagram showing another top substrate according to an exemplary embodiment of the invention. In FIG. 5, there are a plurality of conductive electrodes 511a˜511t formed as an array on the top substrate 51 whereas the plural conductive electrodes 511a ˜511t are connected to their corresponding signal lines 512a˜512e in respective while all the signal lines 512a˜512e are extending following a same extending direction as indicated by the arrow A. Please refer to FIG. 6, which is a schematic diagram showing further another top substrate according to an exemplary embodiment of the invention. In FIG. 6, there are a plurality of conductive electrodes 611a˜611t formed as an array on the top substrate 61 whereas the plural conductive electrodes 611a˜611t are connected to their corresponding signal lines 612a˜612e in respective while the signal lines 612a and 612b are extending following a same extending direction as indicated by the arrow B and the signal lines 612c˜612e are extending following an opposite direction as indicated by the arrow A. Comparing the two conductive electrode arrangement shown in FIG. 5 and FIG. 6, the dual-direction design of FIG. 6 enables the signal line layout to occupy less space so that the size of the top substrate 61 is smaller that that of the FIG. 5. It is noted that the intervals between the conductive electrodes as well as those of the signal lines shown in FIG. 5 and FIG. 6 are enlarged for illustration which are actually far smaller than those shown in the figures, and is designed under the principle that the layout of the signal line should not adversely affect the touch control area of the touch panel.

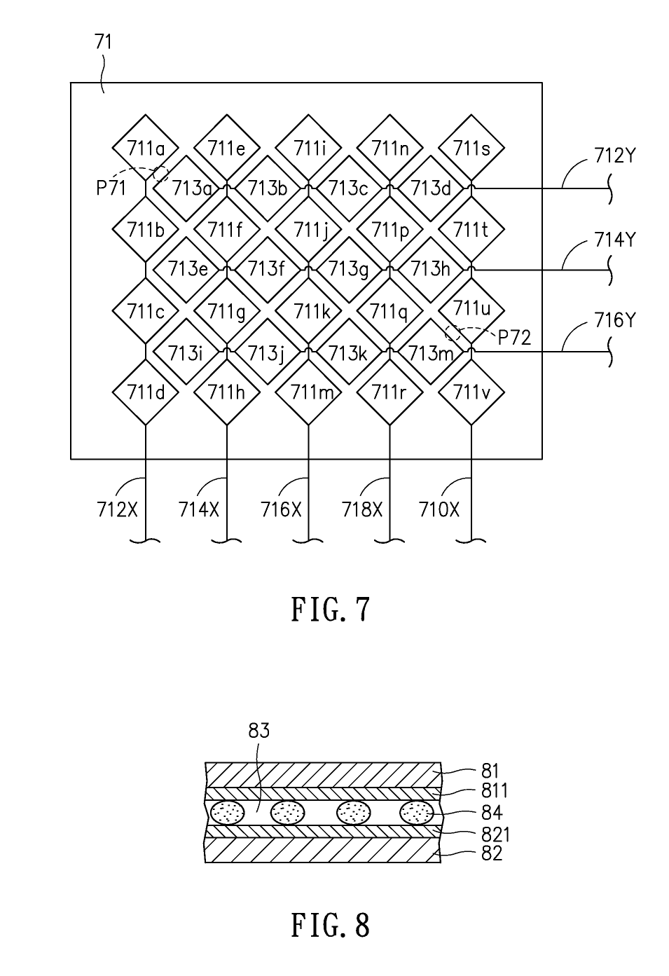

Please refer to FIG. 7, which is a schematic diagram showing another top substrate according to an exemplary embodiment of the invention. The top substrate 71 of FIG. 7 is characterized in that: the top substrate 71 is composed of a plurality of diamond-shaped regions distributed in a array defined by a Cartesian coordinate system of X-axis and Y-axis and each of the plural region has a diamond-shaped conductive electrode formed therein. As the embodiment shown in FIG. 7, there are five columns of diamond-shaped conductive electrodes 711a˜711d, 711e˜711h, 711i˜711m, 711n˜711r and 711s˜711v, extending in the X-axis direction while enabling the conductive electrodes of the same column to be serially connected respectively to a signal line, i.e. the signal line 712x for the column of conductive electrodes 711a˜711d, the signal line 714x for the column of conductive electrodes 711e˜711h, the signal line 716x for the column of conductive electrodes 711i˜711m, the signal line 718x for the column of conductive electrodes 711n˜711r and the signal line 710x for the column of conductive electrodes 711s˜711v; and moreover, there are three rows of diamond-shaped conductive electrodes 713a˜713d, 713e˜713h, and 713i˜713m, arranged in the gaps between the columns of the conductive electrodes 711a˜711d, 711e˜711h, 711i˜711m, 711n˜711r and 711s˜711v, while enabling the conductive electrodes of the same row to be serially connected respectively to a signal line, i.e. the signal line 712y for the row of conductive electrodes 713a˜713d, the signal line 714y for the row of conductive electrodes 713e˜713h, the signal line 716y for the row of conductive electrodes 7713i˜713m; and there is an insulating layer being disposed in spaces between the rows and the columns for preventing short circuit from happening by the cross-over between the electrodes arranged in rows of X-axis direction and the electrodes arranged in columns of Y-axis direction. As the insulating layer is disposed for preventing short circuit, the jumping lines used in the FIG. 7 is only for illustrating that the line connecting the electrodes 713a and 713b will not cross with and thus in contact with the line connecting the electrodes 711e and 711f for instance. By the aforesaid arrangement, when a contact point is relating to two neighboring electrodes or more than two neighboring electrodes, the location of such contact point can be identified by the X-axis signal lines 712x, 714x, 716x, 718x, 710x and the Y-axis signal lines 712y, 714y, 716y. As shown in FIG. 7, the contact point P71 touches the conductive electrodes 711a and 713a so that coordinate of the contact point P71 is identified by the use of the signal lines 712x and 712y; and as the same time that the contact point P72 touches conductive electrodes 711u and 713m, it coordinate is identified by the use of the signal lines 710x and 716y simultaneously.

From the descriptions relating to the embodiments shown in FIG. 2 to FIG. 7, it is concluded that the resistive touch panel of the invention is characterized in its plural conductive electrodes formed on its top substrate, which can be formed as regular polygons or irregular polygon, while being arranged in an array or being irregularly distributed. In addition, for preventing the top substrate from contacting with the bottom substrate when the touch panel is not pressed, there is an insulating layer being formed between the top and the bottom substrate, as the one shown in FIG. 8. In FIG. 8, the touch panel is also comprised of a to substrate 81 and a bottom substrate 82, between which there are two layers of conductive electrode 811, 821 being formed respectively on surfaces of the two substrates 81, 82 facing toward each other. In addition, there is an insulating layer 83 sandwiched between the two conductive electrode layers 811, 821 which has a plurality of spacers 81 formed therein. In an embodiment, the spacers 84 can be made of a material selected from the group consisting of: a glass, a plastic, a polymer material, an oxide particle and the combination thereof; and can be disposed in a position between the top and the bottom substrates 81, 82 by a means of printing, lithographic exposure, spraying or coating. It is noted that the size of the spacer 84, including height, thickness and shape, is determined according actual requirement. By the height of the spacers 84, the top substrate 81 is spaced from the bottom substrate 82 by an interval ranged between 1 micron and 1000 microns when the touch panel is not being pressed. Consequently, by the disposition of the spacers 84, it is ensured that the conductive electrodes 811 formed on the top substrate 81 will not contact with the conductive electrode 821 formed on the bottom electrode 82 when the touch panel is not being pressed.

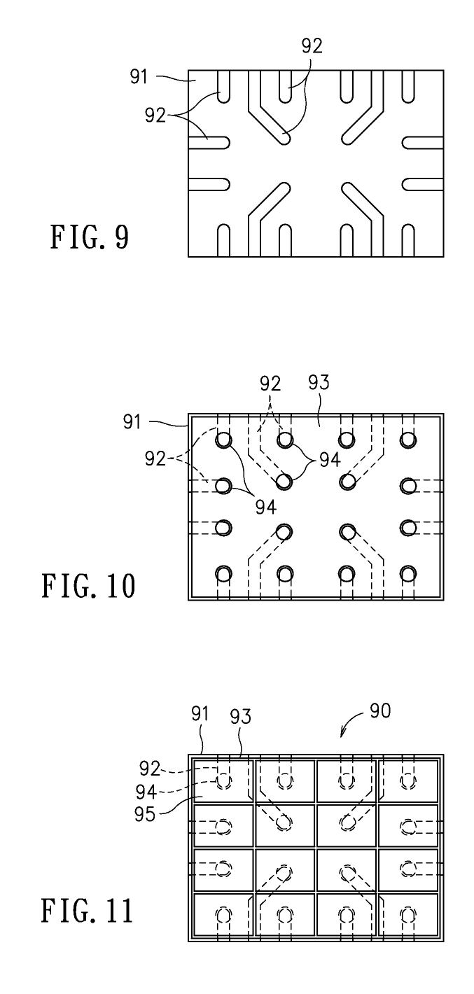

Please refer to FIG. 9 to FIG. 11, which show a formation process of a top substrate used in a resistive touch panel of the invention in a step-by-step manner as well as the structure thereof. The formation of the top substrate is performed by an embedding method. In FIG. 9, the formation process begins by etching a plurality of signal lines 92 on a transparent conductive substrate 91, whereas the shapes of the signal lines 92 are designed according to actual requirement without ant restriction. In Then, an insulating layer is plated on the substrate 91 etched with the signal lines 92 in a manner that each signal line 92 is only exposed through one corresponding opening 94 while enabling the other portion of each signal line 92 to be buried under the insulating layer 93, as shown in FIG. 10. Finally, a plurality of conductive electrodes 95 are formed on the insulating layer 93 at positions corresponding to the openings 94 in an one-to-one manner so as to complete a top substrate 90, as shown in FIG. 11. By the aforesaid embedding method, the intervals between the conductive electrodes are minimized so that erroneous operations, such as unintentionally touch or mistakenly placing a touch at non-working area, can be prevented.

To sum up, the present invention provides a resistive touch panel capable of detect the voltage variations relating to each and every one of multiple simultaneous touches on its top substrate and also capable of identifying the location of those touches in a Cartesian coordinate system, and thereby, enabling the resistive touch panel to have not only a handwriting recognition ability, but also a multi-touch recognition ability as well as a touch-behavior identification ability.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A resistive touch panel with multi-touch recognition ability, comprising:
a top substrate, configured with at least two conductive electrodes;
a bottom substrate, capable of being adhered and integrated with the top substrate at the surface where the at least two conductive electrodes are formed;
and an insulating layer, sandwiched between the top substrate and the bottom substrate;
wherein the bottom substrate is configured with four conductive electrodes to be used for forming two electric fields, one varying along an X-axis direction on a plane defined by a Cartesian coordinate system while enabling the other one to vary along a Y-axis direction of the same.

2. The resistive touch panel of claim 1, wherein the plural conductive electrodes on the top substrate are formed in a shape selected from the group consisting of: regular polygons, irregular polygons and other geometrical shapes.

3. The resistive touch panel of claim 1, wherein each of the plural conductive electrodes on the top substrate is connected to a signal line in respective.

4. The resistive touch panel of claim 1, wherein the insulating layer is substantially a layer of air having a plurality of spacers being disposed therein.

5. The resistive touch panel of claim 4, wherein the spaces are made of a material selected from the group consisting of: a glass, a plastic, a polymer material, an oxide particle and the combination thereof.

6. The resistive touch panel of claim 4, wherein the spacers are disposed for enabling the top substrate to be spaced from the bottom substrate by an interval ranged between 1 micron and 1000 microns when the touch panel is not being pressed.

7. The resistive touch panel of claim 1, wherein the top substrate and the bottom substrate are made of a transparent material selected from the group consisting of: a glass, an acrylic, poly carbonate (PC), polyethylene terephthalate (PET), and polyimide (PI).

8. The resistive touch panel of claim 1, wherein the conductive electrodes formed on the top and the bottom substrates are made of a transparent conductive material selected from the group consisting of: indium-tin oxide (ITO), indium doped zinc oxide (IZO), aluminum zinc oxide (AZO), Zinc oxide (ZnO), tin oxide (SnO).

9. The resistive touch panel of claim 1, wherein the insulating layer is made of a material selected from the group consisting of: an oxide and an organic polymer insulating material.

10. The resistive touch panel of claim 1, wherein the plural conductive electrodes are formed on the top substrate in a manner selected from the group consisting of: being structured as an array, and being structured in an irregular arrangement.

11. The resistive touch panel of claim 1, wherein the top substrate has at least four conductive electrodes.

12. The resistive touch panel of claim 11, wherein the top substrate has eight conductive electrodes.

13. The resistive touch panel of claim 11, wherein the conductive electrodes are radially formed on the top substrate.

14. The resistive touch panel of claim 13, wherein the top substrate has thirty-eight conductive electrodes.

15. The resistive touch panel of claim 11, wherein the plural conductive electrodes are formed on the top substrate as an array while each being respectively connected to a signal line as all the signal lines are extending following a same extending direction.

16. The resistive touch panel of claim 11, wherein the plural conductive electrodes are formed on the top substrate as an array while each being respectively connected to a signal line as one signal line is extending following an extending direction and all the other signal lines are extending following another extending direction.

17. The resistive touch panel of claim 11, wherein the plural conductive electrodes of the top substrate are in a diamond shape and are structured in an array.

18. The resistive touch panel of claim 18, wherein the top substrate has thirty-two conductive electrodes includes:
a plurality of electrodes selected from the thirty-two conductive electrodes, being divided into groups and arranged in parallel rows extending in the X-axis direction while enabling each row to be serially connected respectively to a signal line;
a plurality of electrodes selected from those not included in the rows, being divided into groups and arranged in parallel columns extending in the Y-axis direction while enabling each column to be serially connected respectively to a signal line;
an insulating layer, being disposed in spaces between the rows and the columns for preventing short circuit from happening by the cross-over between the electrodes arranged in rows of X-axis direction and the electrodes arranged in columns of Y-axis direction.

19. The resistive touch panel of claim 19, wherein the top substrate has thirty-two conductive electrodes includes:
twenty electrodes selected from the thirty-two conductive electrodes, being divided into five groups and arranged in five parallel rows as each row contains four conductive electrodes;
twelve electrodes selected from those not included in the rows, being divided into three groups and arranged in three parallel columns as each column contains four conductive electrodes.

20. The resistive touch panel of claim 1, further comprising:
a plurality of signal lines, each being etched on the bottom substrate.
